(19) United States
(12) Patent Application Publication
(10) Pub. No.: US 2007/0066326 A1
(43) Pub. Date: Mar. 22, 2007

(54) Methods, systems, and computer program products for facilitating delivery of messaging service messages between domains of different type

(75) Inventors: Devesh Agarwal, Raleigh, NC (US); Robby D. Benedyk, Angier, NC (US); Warren Ferguson, Cary, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/413,063

(22) Filed: Apr. 27, 2006

Related U.S. Application Data
(60) Provisional application No. 60/718,653, filed on Sep. 20, 2005.

(51) Int. Cl. H04Q 7/20

(52) U.S. Cl. 455/466

(57) ABSTRACT

Methods, systems, and computer program products for facilitating delivery of messaging service messages between domains of different type are disclosed. According to one method, a messaging service message including a messaging service address parameter storing a first address value is received. It is determined whether the messaging service message is being sent from a domain of the first domain type to a second domain of the second domain type, where the first domain type is different from the second domain type. It is also determined whether the message is of a type used to communicate an MS delivery address at which a mobile station can receive MS messages. In response to the determination that the messaging service message is being sent from the first domain of the first domain type to the second domain of the second domain type and the determination that the message is of a type used to communicate an MS delivery address at which a mobile station can receive MS messages, the first address value is replaced with a second address value of the second domain type.

### RELATED APPLICATION

This application claims the benefit of U.S. Provisional Patent Application Ser. No. 60/718,653, filed Sep. 20, 2005, the disclosure of which is hereby incorporated herein by reference in its entirety.

### TECHNICAL FIELD

The subject matter described herein relates to the distribution and processing of messages in a communications network. More particularly, the subject matter described herein relates to methods, systems, and computer program products for facilitating delivery of messaging service messages between domains of different type.

### BACKGROUND ART

Short message service (SMS) enables mobile subscribers to easily send and receive text messages via wireless handsets. Although specifications and industry standards related to SMS are constantly evolving and being modified, SMS messages have traditionally been used to convey readable text information, where the text can include any combination of characters that can be entered via a keypad or keyboard. Multimedia message service (MMS) extends the basic SMS concept to include a variety of message content types, including text, still images, video, and audio. The term “messaging service message,” as used herein, is intended to refer generically to any telecommunications signaling message that carries media content, such as SMS or MMS content.

SMS delivery service provides a mechanism for transmitting messages to and from SMS capable terminals (e.g., wireless handsets, personal computers, etc.) via the signaling component of the wireless communications network. With particular regard to the sending and receiving of SMS messages by a wireless handset, a signaling network provides the transport facilities necessary to communicate short messages between a store-and-forward network element, known as a short message service center (SMSC), and a wireless handset. In contrast to earlier text message transmission services, such as alphanumeric paging, SMS technology is designed to provide guaranteed delivery of an SMS message to a destination. That is, if a temporary network failure or the unavailability of a message recipient prohibits the immediate delivery of an SMS message, then the SMS message is stored in the network (i.e., at an SMSC) until the destination/intended message recipient becomes available.

As stated above, messaging service messages are delivered using signaling messages in SS7 networks. In SS7 networks, the domain type defines the point code format used to identify nodes in the network. For example, in North America, the American National Standards Institute (ANSI) domain type is used. Nodes in an ANSI domain use 24-bit point codes. In Europe, some countries use the International Telecommunications Union National (ITU-N) domain type. The ITU-N domain type corresponds to a 14-bit point code format. Still other countries may use ITU international (ITU-I) point code formats or other national variants. In SS7 network terminology, a domain refers to all or part of a network where a common point code format is used. For example, a telecommunications service provider may have a network that is divided into different domains. In another example, service providers may each manage domains of a single type. However, the domain types of different service providers may differ.

One problem that occurs when signaling messages are communicated between domains of different type is that the point codes used by one domain type may be incompatible with those used by another domain type. Since point codes in domains of different domain type can be incompatible, MTP level 3 point code converters have been developed. For example, the Assignee of the present application has developed an ANSI-ITU point code converter that converts the MTP level 3 point code of a message between ANSI and ITU point code formats. While such point code converters are effective at communicating messages between domains of different type, such converters fail to convert address information in higher layers of the message, such as application layers of a message, which are used to deliver messaging service messages. For example, when a mobile terminal is activated, the serving MSCNLR in the area where the mobile terminal is activated sends a registration message to the mobile terminal's home HLR. The registration message contains a messaging service address, which may include an entity address associated with the serving MSCNLR, an SS7 point code associated with the serving MSCNLR, or other network address. In cases where a subscriber belonging to a home ITU network roams into an ANSI network and where the messaging service address is an SS7 point code, the SS7 point code in messaging service address field of the registration message will have an ANSI domain type, even though the subscriber's home HLR is in an ITU domain. When another subscriber attempts to send a messaging service message to the roaming subscriber, the registering subscriber's home HLR is queried by the SMSC in the roaming subscriber's home ITU network. In this hypothetical example, the HLR would respond with the ANSI point code associated with the serving MSCNLR in response to the query. However, the ITU SMSC associated with the ITU core network attempting to deliver the SMS message will be incapable of delivering the message because the ANSI point code provided to the ITU SMSC is unroutable in the ITU network.

In order to allow delivery of SMS messages between domains of different type, SMS protocol converters have been developed. An SMS protocol converter converts from the application level protocol, such as IS-41 or GSM mobile application part (MAP) to an intermediate protocol format, such as short message point-to-point (SMPP). An SMPP message may be used by the sending SMSC to deliver the SMS message to an SMSC in the domain of the different type in which the subscriber is currently located. The SMSC may convert the application layer protocol of the message to that corresponding to the destination MSC and forward the message to the destination MSC.

While application layer protocol conversion is effective in delivering SMS messages between domains of different type, it requires that both the sending and receiving SMSC be capable of converting between their local application layer protocols, such as IS-41 or GSM MAP and an intermediate delivery protocol, such as SMPP. Requiring such protocol conversion is unduly burdensome on the sending and receiving SMSCs and thus should be avoided.

Accordingly, based on the foregoing, there exists a need for improved methods, systems, and computer program products for facilitating delivery of messaging service messages between domains of different type.

### SUMMARY

The subject matter described herein includes methods, systems, and computer program products for facilitating delivery of messaging service messages between domains of different type. According to one aspect, a method according to the subject matter described herein includes receiving messaging service message including an including a messaging service address parameter or field located in an application part of the message. The messaging service address parameter or field may store a first address value. The method may further include determining whether the message is being sent from a first domain of a first domain type to a second domain of a second domain type, the first domain type being different from the second domain type. It may also be determined whether the message is of a type used to communicate an MS delivery address at which a mobile station can receive MS messages. In response to determining that the message is being sent from a domain of a first domain type to a domain of a second domain type and a determination that the message is of a type used to communicate an MS delivery address at which a mobile station can receive MS messages, the first address value is replaced with a second address value of the second domain type. The messaging service message is then forwarded to the second domain.

The subject matter described herein for facilitating delivery of messaging service messages between domains of different type may be implemented using a computer program product comprising computer executable instructions embodied in a computer readable medium. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Exemplary embodiments of the subject matter will now be explained with reference to the accompanying drawings, of which:

FIG. 1 is a network diagram illustrating a communications network environment including a messaging service message routing node for facilitating delivery of messaging service messages between networks of different domain type according to an embodiment of the subject matter described herein;

FIG. 2 is an exemplary message flow diagram associated with the registration of a wireless handset in a network environment including a messaging service message routing node for facilitating delivery of messaging service messages between networks having different domain types according to an embodiment of the subject matter described herein;

FIG. 3 is an exemplary message flow diagram associated with delivery of an SMS notification message in a network environment including a messaging service message routing node for facilitating delivery of messaging service messages between domains of different type according to an embodiment of the subject matter described herein;

FIG. 4 is an exemplary message flow diagram associated with delivery of an SMS request return result message in a network environment including a messaging service message routing node for facilitating delivery of messaging service messages between domains of different type according to an embodiment of the subject matter described herein;

FIG. 5 is a schematic diagram illustrating an exemplary internal architecture of a messaging service message routing node for facilitating delivery of messaging service messages between domains of different type according to an embodiment of the subject matter described herein; and

FIGS. 6A, 6B, and 6C are a flow chart of an exemplary process for facilitating delivery of messaging service messages between domains of different type according to an embodiment of the subject matter described herein.

### DETAILED DESCRIPTION

According to one embodiment, the subject matter described herein includes a communications network routing node, referred to herein as a messaging service message (MSM) routing node. The MSM routing node may be configured to replace a messaging service address in an application part of a received messaging service (MS) message in response to two determinations. The first determination may be that the messaging service message is being sent between domains of different type. The second determination may be that the message is of a type used to communicate an MS delivery address for a mobile terminal, where the MS delivery address corresponds to the MSC or VLR currently serving the mobile terminal.

MS messages received by MSM routing node 102 can be IS-41 or GSM mobile application part (MAP) messages communicated between domains of different type, such as ANSI and ITU domain types. If the message is being sent from an ANSI domain to an ITU domain and is of the type used to communicate the MSC address where the mobile terminal can receive SMS messages, MSM routing node 102 may detect this fact and replace an ANSI point code value contained in a messaging service address field located in the application part of the message with an alias ITU point code. The alias ITU point code may correspond to a serving MSCNLR in the ANSI domain. In a similar manner, if the message is being sent from an ITU domain to an ANSI domain and is of the type used to communicate the MSC address where the mobile terminal can receive SMS messages, the ITU point code located in the MS address field in the application part of the message is replaced by an alias ANSI point code corresponding to a serving MSCNLR in the ITU domain.

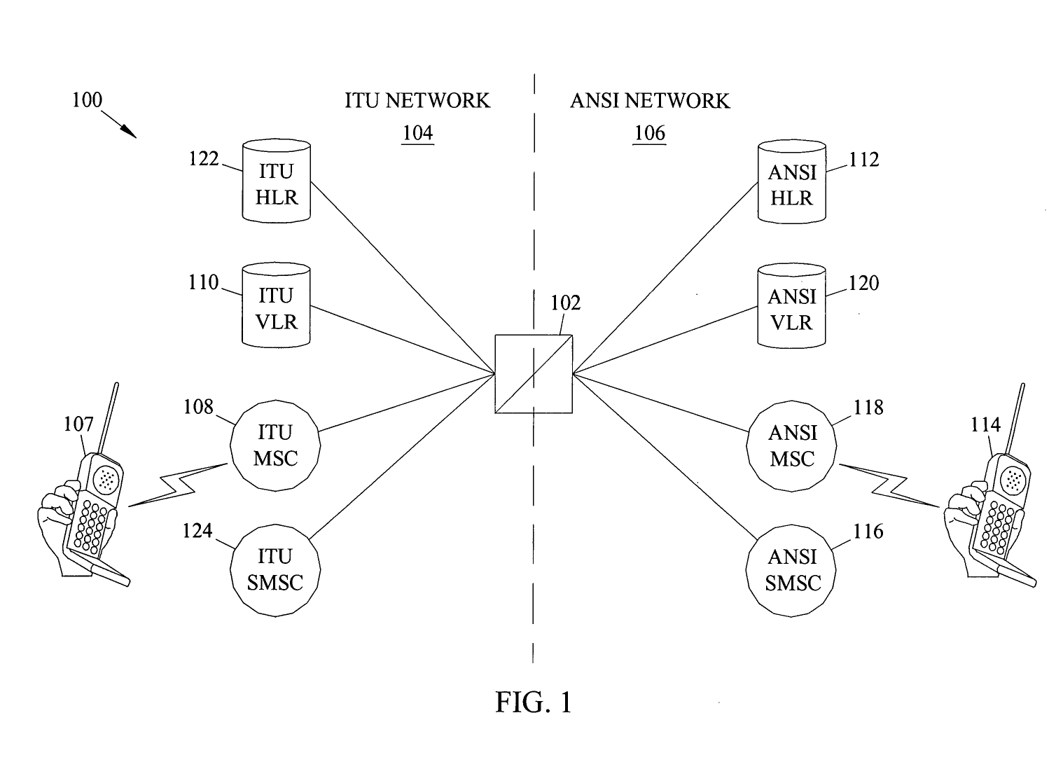

FIG. 1 is a network diagram illustrating a communications network environment 100 including a messaging service message routing node 102 for facilitating delivery of messaging service messages between an ITU domain 104 and an ANSI domain 106 according to an embodiment of the subject matter described herein. Because ITU domain 104 and ANSI domain 106 are of different domain type, the messaging service delivery addresses used by each domain are unroutable to nodes of the other domain type. For example, the ITU messaging service address used to deliver messaging service messages to subscribers currently located in ITU domain 104 is unroutable to nodes in ANSI domain 106. Similarly, the ANSI messaging service address used to deliver messaging service messages to subscribers currently located in ANSI domain 106 is unroutable to nodes in ITU domain 104.

In order to avoid this difficulty, rather than converting each messaging service message to an intermediate format, such as SMPP, messaging service message routing node 102 replaces the address value stored in MS address parameter in the message with an alias address. The alias address is mapped in the routing tables of messaging service message routing node 102 to the true point code of the serving MSCNLR.

For example, in the network illustrated in FIG. 1, when a mobile terminal 107 is activated in ITU domain 104, mobile terminal 107 sends a registration message to ITU mobile switching center 108. ITU mobile switching center 108 sends a registration notification message to ITU VLR 110. The registration notification message includes a short message service (SMS) address parameter storing an address value identifying the MSC element currently serving mobile terminal 107. For example, the SMS address parameter may contain an ITU-formatted SS7 point code associated with serving ITU MSC 108. ITU VLR 110 forwards the registration notification message to messaging service message routing node 102. Messaging service message routing node 102 replaces the address value stored in the SMS address parameter located in the MAP portion of the message with an alias ANSI point code that has been mapped to or associated with the true ITU point code of ITU MSC 108. As used herein, the term “true point code” refers to the point code used for MTP level 3 routing of messages within a domain. The converted registration notification message may be forwarded to ANSI HLR 112, which may correspond to the home HLR for mobile terminal 107. When a mobile terminal 114 attempts to send an SMS message to mobile terminal 107, ANSI SMSC 116 queries ANSI HLR 112, and ANSI HLR 112 responds with the alias ANSI SMS address that messaging service message routing node 102 uses to identify ITU MSC 108. ANSI HLR 112 forwards the ANSI SMS address to ANSI SMSC 116. ANSI SMSC 116 then generates an SMS Delivery Point-to-Point message that includes the SMS content and forwards the SMS Delivery Point-to-Point message, which is MTP addressed to the alias ANSI point code provide by HLR 112. The SMS Delivery Point-to-Point message includes the SMS payload content and is forwarded to messaging service message routing node 102. Messaging service message routing node 102 receives the SMS Delivery Point-to-Point message, determines that it is destined for an ITU domain, replaces the ANSI alias point code in the MTP level 3 destination point code field of the message with the true ITU point code corresponding to ITU MSC 108. Messaging service message routing node 102 then forwards the message to ITU MSC 108 for delivery to mobile terminal 107.

A similar procedure to that described above may be followed for sending an SMS message from ITU domain 104 to ANSI domain 106. In such a scenario, when mobile subscriber 114 registers with ANSI MSC 118, the registration may be communicated to ANSI VLR 120. ANSI VLR 120 may send a registration notification message to ITU HLR 122. Messaging service message routing node 102 may replace the value stored in the SMS address parameter in the application part of the registration notification message with an alias ITU point code associated with ANSI MSC 118 so that HLR 122 will store the alias ITU address that messaging service routing node 102 has mapped or associated with ANSI MSC 118. When ITU SMSC 124 originates an SMS message destined for subscriber 114, ITU SMSC 124 will query ITU HLR 122, obtain the alias ITU address, incorporate the alias ITU point code in the MTP level 3 destination point code field of the message, and forward the message to messaging service message routing node 102. Messaging service routing node 102 will then replace the alias ITU point code in the MTP layer 3 destination point code field of the message with the ANSI point code of ANSI MSC 118 and forward the message to subscriber 114 via ANSI MSC 118.

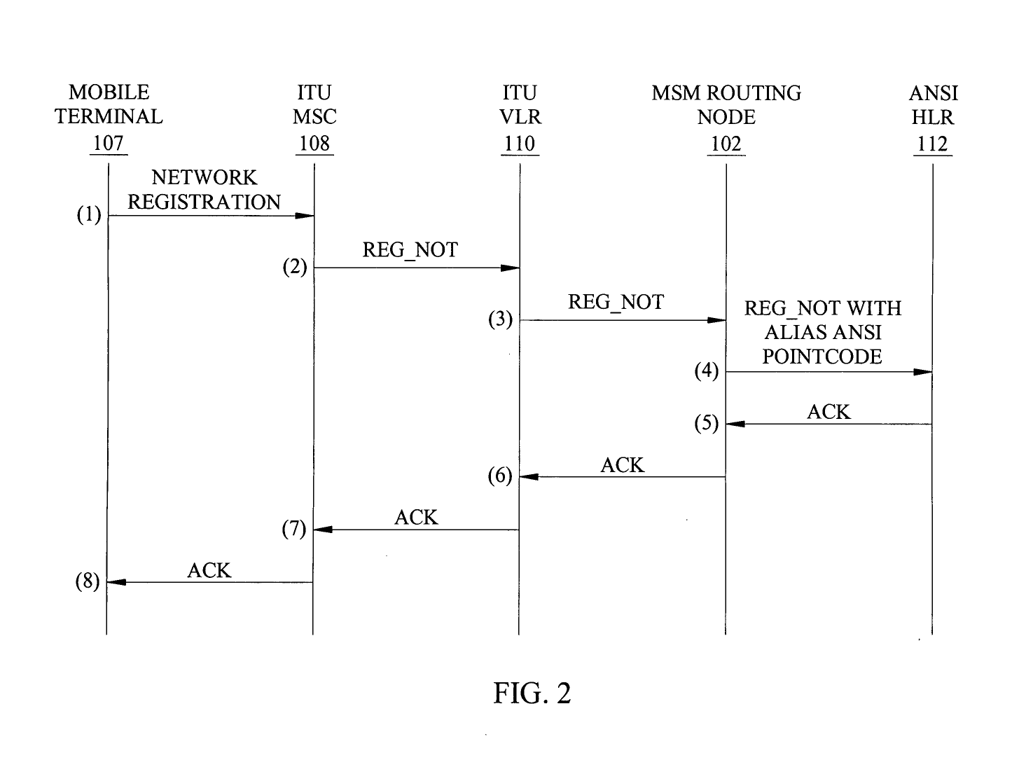

Exemplary signaling message flows illustrating messages exchanged between the nodes illustrated in FIG. 1 in delivering messaging service messages between domains of different type will now be described in detail. FIGS. 2-4 are exemplary message flow diagrams of the transmission of these messages in network environment 100 shown in FIG. 1. Referring to FIG. 2, a message flow diagram is illustrated that is associated with the registration of mobile terminal 107 in network environment 100 according to an embodiment of the subject matter described herein. In this example, mobile terminal 107 is activated and roaming in ITU domain 104. Further, in this example, the home network of mobile terminal 107 is within ANSI domain 106. Initially, in step 1, mobile terminal 107 transmits a network registration request message to ITU MSC 108. In step 2, ITU MSC 108 transmits a registration notification message (REGNOT) to ITU VLR 110. The registration notification message may include a MAP layer SMS address parameter storing an address value corresponding to ITU MSC 108. The address value may be a point code in ITU format.

Referring to step 3 of FIG. 2, ITU VLR 110 transmits a registration notification message to routing node 102 for forwarding to ANSI HLR 112. The registration notification message may contain the SMS address field storing the ITU point code of serving ITU MSC 108. According to one embodiment of the subject matter described herein, routing node 102 may examine the received message and determine whether the message is a message type identified for messaging service (MS) address replacement. In one exemplary implementation, messages identified for messaging service address replacement may be those messages sent from a domain of a first domain type to a domain of a second domain type used to communicate the messaging service address at which a roaming mobile station can receive messages in the domain of the first domain type. In IS-41 networks, these message types include registration notification, which is used to communicate a mobile station registration to an HLR, SMS notification, which is used to report a change in a mobile station's ability to receive SMS messages based on the location or status of the mobile station, and SMS request return result, which is sent in response to an SMS request invoke message requesting a mobile station's current SMS routing address. In FIG. 2, the received message is a registration notification message. Therefore, the message is a type identified for MS address replacement. Routing node 102 may determine that the message is a registration notification message by examining the TCAP operation code of the message. If the message is not a message identified for MS address replacement, the message will be routed and processed by routing node 102 without MS address replacement.

Further, routing node 102 may determine whether the message is being sent between domains of different type by examining the destination point code in the MTP routing label of the registration notification message and determining whether the destination point code is an alias point code. This determination may be made using the destination point code value to perform a lookup in a routing table of MSM routing node 102. If the lookup results in an entry that includes an ITU point code corresponding to the ANSI point code in the message, the ANSI point code may be determined to be an alias.

If it is determined that the received registration message is being sent from an ITU domain to an ANSI domain, the ITU point code in the MS address field of the message may be replaced by an alias ANSI point code. The replacement can include searching a routing table for an alias ANSI point code associated with the ITU point code. The ANSI point code is an alias point code that is mapped to the true ITU point code of ITU MSC 108 in one or more tables stored in MSM routing node 102. Conversely, for a registration notification message being communicated from the ANSI domain to the ITU domain, the ANSI point code in the MS address field of the message may be replaced by an alias ITU point code. The alias ITU point code may be a point code that is mapped to the true ANSI point code of the serving MSCNLR in one or more tables stored in MSM routing node 102.

Referring to step 4 of FIG. 2, routing node 102 transmits the registration notification message including the alias ANSI point code to ANSI HLR 112. ANSI HLR 112 may store the registration information including the alias ANSI point code. Next, in step 5, HLR 112 can communicate an acknowledgement message to routing node 102. Routing node 102 can communicate the acknowledgement message to VLR 110 (step 6), which forwards the acknowledgement message to MSC 108 (step 7). MSC 108 can forward the acknowledgement message to handset 107 (step 8).

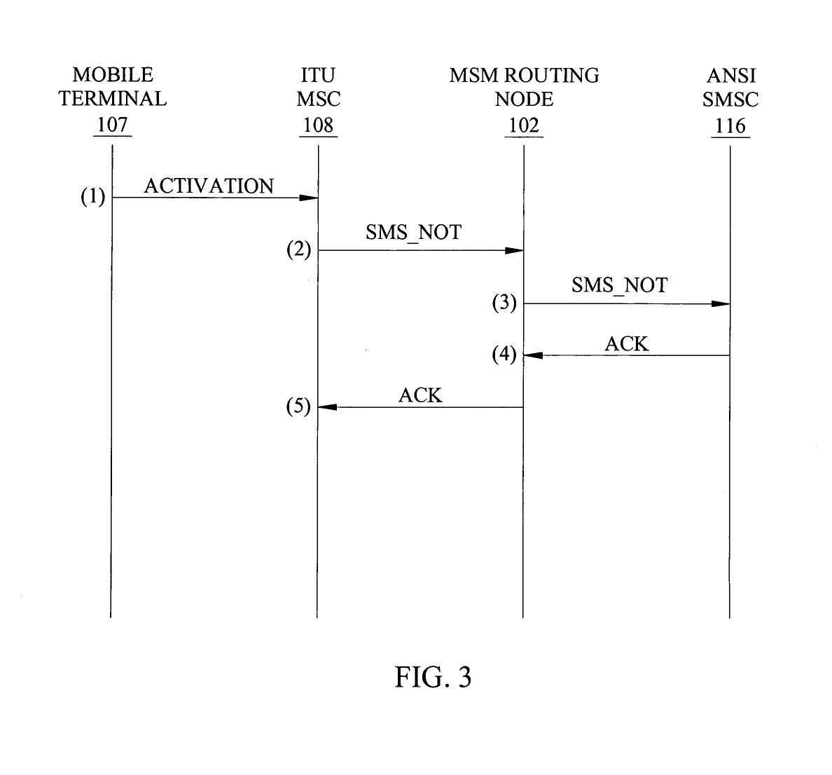

FIG. 3 is an exemplary message flow diagram associated with delivery of an SMS notification message generated by activation of mobile terminal 107 according to an embodiment of the subject matter described herein. As described above, an SMS notification message is a message used to report a change in a mobile station's ability to receive SMS messages based on the location or status of the mobile station. The SMS notification message carries the SMS address of the MSC at which the handset is capable of receiving SMS messages. Accordingly, in line 1 of the message flow diagram, mobile terminal 107 sends an activation message to ITU MSC 108. Mobile terminal 107 may be previously registered with ITU MSC 108. In line 2 of the message flow diagram, ITU MSC 108 sends an SMS notification message to MSM routing node 102. The SMS notification message may be MTP-addressed to the alias ITU point code for ANSI SMSC 116. MSM routing node 102 may replace the alias ITU point code in the MTP DPC field with the true ANSI point code of ANSI SMSC 116. In addition, according the subject matter described herein, routing node 102 may replace the true ITU point code corresponding to serving ITU MSC 108 in the SMS address field of the message with an alias ANSI point code that is mapped by routing node 102 to the true ITU point code of ITU MSC 108. In line 3 of the message flow diagram, routing node 102 communicates the SMS notification message to ANSI SMSC 116. In line 4 of the message flow diagram, ANSI SMSC 116 acknowledges the SMS notification message, and in line 5 of the message flow diagram, the acknowledgement message is communicated to ITU MSC 108.

Because ANSI SMSC 116 receives an SMS notification message with an alias ANSI point code in the MS address field of the message, ANSI SMSC 116 can use this address to MTP address subsequent SMS messages and forward the SMS messages to mobile terminal 107 without requiring conversion to an intermediate signaling message format, such as SMPP format. In order to initiate delivery of such a message, ANSI SMSC 116 would initiate an SMS delivery point-to-point message that is MTP addressed to the alias ANSI point code of ITU MSC 108. MSM routing node 102 would convert the MTP layer 3 destination point code in the message to the true ITU point code of ITU MSC 108 and route the message to ITU MSC 108.

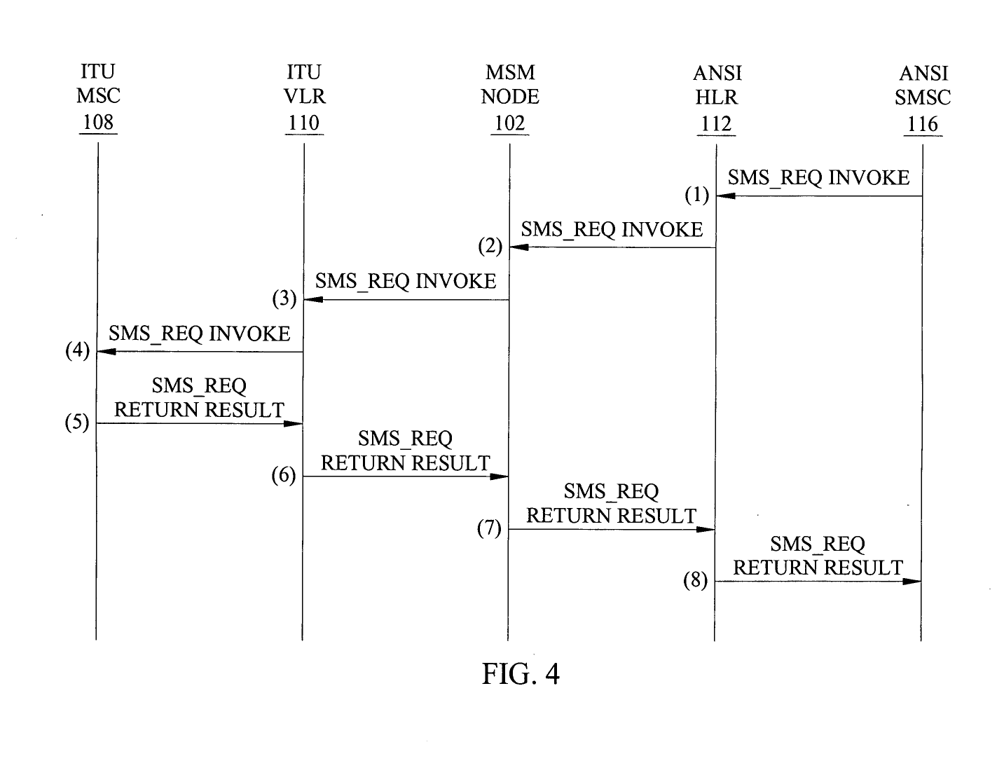

As stated above, another type of message for which it may be desirable to replace the address value stored in the SMS address parameter in the application layer of the message with an alias address is an SMS request return result message. As stated above, an SMS request return result message is a message sent in response to an SMS request invoke message used to request a mobile station's current SMS routing address with a default to request notification when the mobile station becomes available if the mobile station is not currently available. FIG. 4 is a message flow diagram illustrating exemplary messages exchanged in an SMS request transaction between domains of different type according to an embodiment of the subject matter described herein. Referring to FIG. 4, in line 1 of the message flow diagram, ANSI SMSC 116 sends an SMS request invoke message requesting the current SMS routing address of mobile terminal 107. Mobile terminal 107 is assumed to be roaming in ITU domain 104. The SMS request invoke message is sent to ANSI HLR 112, which the home HLR for mobile terminal 107. In line 2 of the message flow diagram, ANSI HLR 112 sends the SMS request invoke message to MSM routing node 102. The SMS request invoke message may be MTP-addressed to the alias ANSI point code corresponding to ITU VLR 110. MSM routing node 102 may translate the alias ANSI point code to the true ITU point code of ITU VLR 110. In line 3 of the message flow diagram, MSM routing node 102 may forward the SMS request invoke message to ITU VLR 110. In line 4 of the message flow diagram, ITU VLR 110 may initiate SMS request invoke message to ITU MSC 108. In line 5 of the message flow diagram, ITU MSC 108 responds with an SMS request return result message. The SMS request return result message includes an SMS address field located in the MAP portion of the message that stores the ITU point code of ITU MSC 108. In line 6 of the message flow diagram, ITU VLR 110 initiates an SMS request return result message to ANSI HLR 112, which includes the ITU point code of MSC 108 in the SMS address field.

In response to receiving the SMS request return result message, MSM routing node 102 identifies the message as a message that is of a type that requires MS address replacement. In addition, routing node 102 may determine that the SMS request return result message is being transmitted between domains of different type by determining that the DPC value in the message is an alias. Accordingly, MSM routing node 102 may replace the true point code of ITU MSC 108 stored in the SMS address field of the message with an alias ANSI point code that is mapped to the true ITU point code ITU MSC 108 by MSM routing node 102. In line 7 of the message flow diagram, MSM routing node 102 forwards the SMS request return result message with the alias ANSI point code to ANSI HLR 112.

ANSI HLR 112 may store the alias ANSI point code as the current SMS address for the subscriber. In line 8 of the message flow diagram, ANSI HLR 112 forwards the SMS request return result message to ANSI SMSC 116 including the alias ANSI point code that is mapped to the true ITU point code of ITU MSC 108 in the SMS address field. Because ANSI SMSC 116 receives an ANSI-formatted alias point code that MSM routing node 102 maps to the true ITU point code of ITU MSC 108, ANSI SMSC 116 can deliver SMS messages to mobile terminal 107 without requiring that the SMS messages be converted to an intermediate format, such as SMPP, for delivery.

A messaging service message routing node according to the subject matter disclosed herein may include an underlying hardware platform that performs functions similar to that of a traditional telecommunications network packet routing node, such as an SS7/IP-capable signal transfer point (STP) routing node or signaling gateway (SG) routing node. For example, a suitable system for replacing address values stored in SMS address parameters in messages communicated between domains of different type according to the subject matter disclosed herein may include an EAGLE® STP or an IP⁷ SECURE GATEWAY® (both commercially available from Tekelec of Calabasas, Calif.).

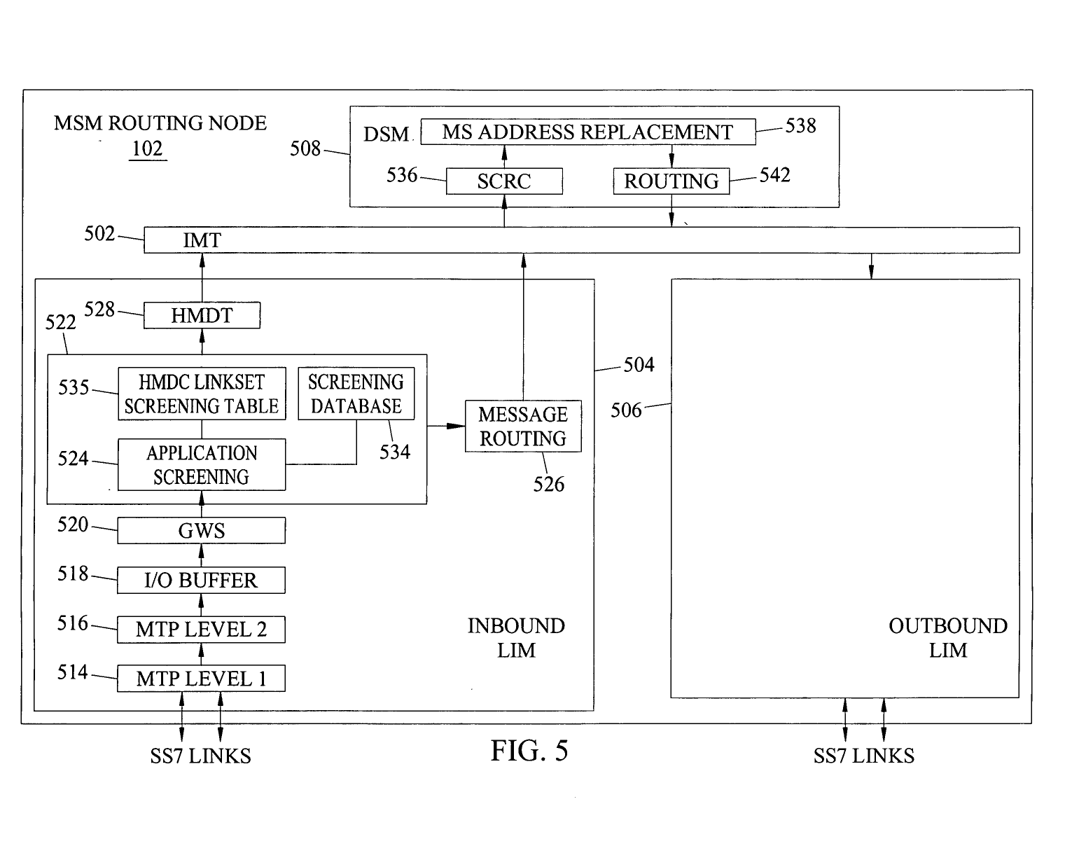

FIG. 5 illustrates an MSM routing node according an embodiment of the subject matter described herein. Referring to FIG. 5, MSM routing node 102 includes an interprocessor message transport (IMT) bus 502 that is the main communication bus among internal subsystems within MSM routing node 500. In one embodiment, this high-speed communications system includes two counter-rotating serial rings. A number of processing modules or cards may be coupled to IMT bus 502. In FIG. 2, IMT bus 502 may be coupled to a link interface module (LIM) 504, a LIM 506, and a database service module (DSM) 508, which includes a messaging service address replacement function. These modules are physically connected to IMT bus 502 such that signaling and other types of messages may be routed internally between active cards or modules. For simplicity of illustration, only two LIMs and a single DSM cards are included in FIG. 5. However, MSM routing node 102 may include multiple other LIMs and DSMs, and other cards, all of which may be simultaneously connected to and communicating via IMT bus 502.

Each module may include an application processor and a communication processor. The communication processor may control communication with other modules via bus 502. The application processor on each module may execute the applications or functions that reside on each module. For example, the application processor on DSM 508 may execute software that implements the SMS address replacement function. Similarly, the application processor on LIM 504 may execute software that implements a screening function for determining whether messages are being sent between domains of different type.

LIM 504 may include an SS7 MTP level 1 function 514, an SS7 MTP level 2 function 516, an I/O buffer 518, a gateway screening (GWS) function 520, an SS7 MTP level 3 message handling and discrimination (HMDC) function 522, including an application screening function 524, a message routing function 526, and a message handling and distribution (HMDT) function 528. MTP level 1 function 514 sends and receives digital data over a particular physical interface. MTP level 2 function 516 provides error detection, error correction, and sequenced delivery of SS7 message packets. I/O buffer 518 provides temporary buffering of incoming and outgoing signaling messages.

GWS function 520 examines received message packets and determines whether the message packets should be allowed into MSM routing node 102 for processing and/or routing. HMDC function 522 performs discrimination operations, which may include determining whether the received message packet requires processing by an internal processing subsystem or is simply to be through switched (i.e., routed on to another node in the network). Messages that are permitted to enter MSM routing node 102 may be routed to other communications modules in the system or distributed to an application engine or processing module via IMT bus 502.

Application screening function 524 may examine received message packets and determine whether the message packets are being communicated between domains of different type, such as ITU domain 104 and ANSI domain 106 shown in FIG. 1. Function 524 may determine whether the message is being sent between domains of different type by examining the destination point code in the MTP routing label of the received message. If the DPC value in the message is an alias, it is known that the message is destined for domain of a different type from the sending domain. If it is determined that the received message is not being sent between domains of different type, the message will be routed by MSM routing node 102 without SMS address replacement. If it is determined that the message is being communicated between domains of different type, the message is forwarded to DSM 508 for possible replacement of an address value stored in an SMS address parameter in the message, depending on the message type.

According to one embodiment, application function 524 can also screen messages received on particular incoming linksets. For example, some linksets may correspond to adjacent nodes, such as wireline SCPs or SSPs, that do not send messaging service message signaling messages. Such nodes are preferably excluded from MS address replacement processing. In order to implement such screening, LIM 504 may include a linkset screening table 535 that that lists either the linkset IDs of linksets that correspond to MS address replacement candidates or those that are not MS conversion candidates. Either implementation is intended to be within the scope of the subject matter described herein.

DSM 508 receives messages identified as MS address replacement candidates. Signaling connection routing controller (SCRC) 536 identifies the application to which a message should be directed based on SCCP information in the message, such as the translation type, nature of address indicator, numbering plan, domain type, subsystem number and/or other SCCP parameters. For messages directed to an HLR or an SMSC, SCRC 536 may forward the messages to MS address replacement function 538.

MS address replacement function 538 determines whether a received message is a message type identified for MS address replacement, e.g., a registration notification message, an SMS notification message, or an SMS request return result message. In a GSM signaling network environment, MS address replacement function 538 may identify GSM messages used to communicate the address at which a mobile station receives SMS messages as candidates for SMS address replacement. One example of such a GSM message is a location update message.

The message type can be identified by examining the TCAP operation code of the forwarded message. If the forwarded message is a type identified for MS address replacement, MS address replacement function 538 may perform the replacement. Otherwise, if the forwarded message is not a type identified for MS address replacement, the message can be further processed and routed by MSM routing node 102 without MS address replacement.

MS address replacement function 538 may replace the point code stored in the SMS address field of a message in response to two determinations. The first determination is whether the message is being sent between domains of different type. This determination may be made by application screening function 524. The second determination is whether the message is of a type used to communicate the SMS delivery address at which a mobile station can receive SMS messages. The second determination may be made by MS address replacement function 538. For example, if the message is being sent from an ITU domain to an ANSI domain and is one of the types used to communicate an MS delivery address (i.e., the address of the serving MSCNLR), MS address replacement function 538 replaces the point code in the SMS address field with an alias ANSI point code. Conversely, if the message is begin sent from an ANSI domain to an ITU domain and is one of the types used to communicate an MS delivery address, MS address replacement function 538 replaces the point code in the SMS address field with an alias ITU point code. After SMS address replacement, the message can be forwarded to a routing function 542 for routing to outbound LIM 506 via IMT bus 502. LIM 506 forwards the message to the destination network.

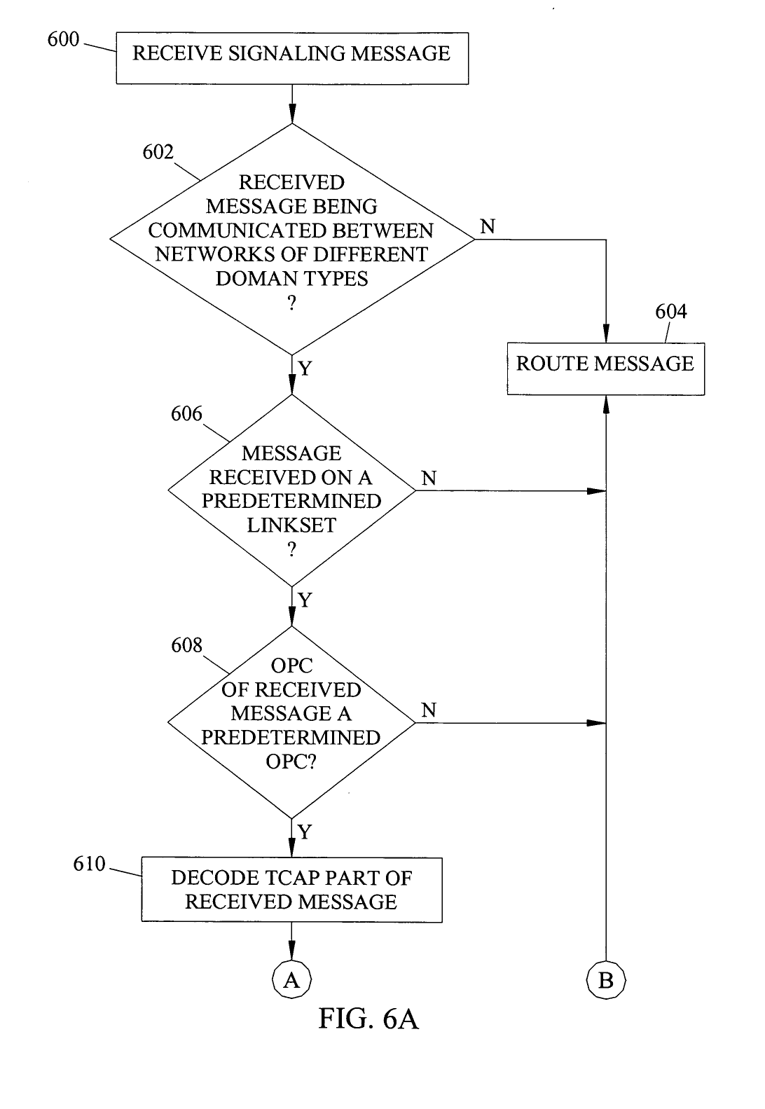

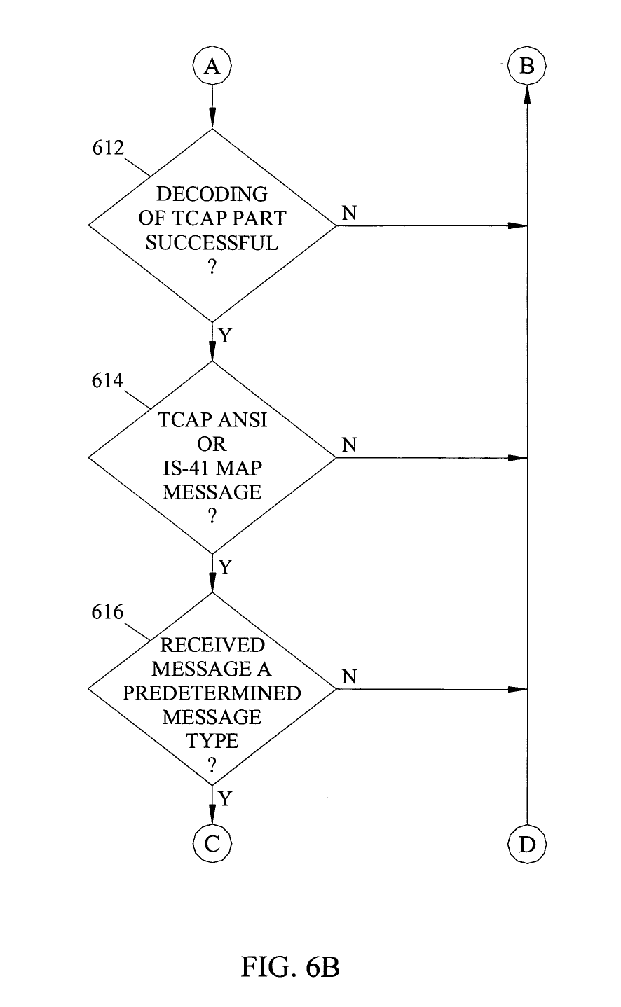

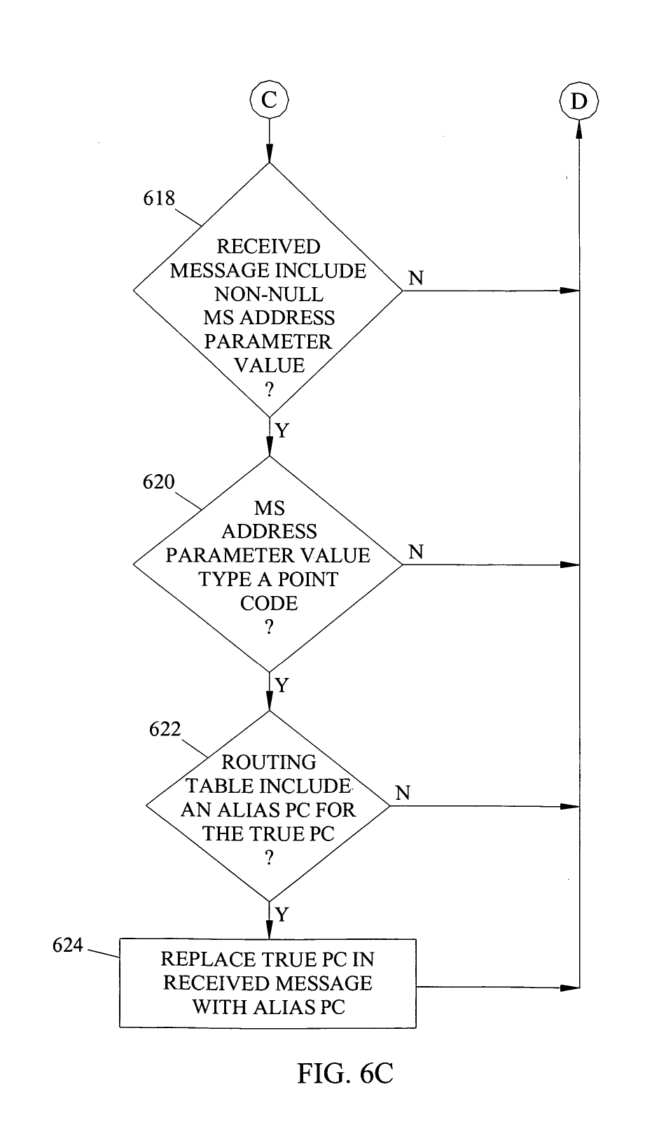

FIGS. 6A, 6B, and 6C are a flow chart of an exemplary process associated with replacing an SMS address of a signaling message according to an embodiment of the subject matter disclosed herein. In this example, the signaling messages are MTP-routed signaling messages that contain a TCAP/MAP layer. Referring to FIG. 6A, in step 600, a signaling message may be received. For example, the signaling messaging may be received at LIM 504 (illustrated in FIG. 5) and may be passed up the stack to application screening function 524. The received signaling message may be a registration notification message, an SMS request return result message, an SMS notification message, or one of the corresponding GSM messages that is being transmitted between domains of different type. Further, the received message can include an MS address parameter.

Referring to step 602, it is determined whether the received message is being transmitted between domains of different type. This step may be performed by application screening function 524 illustrated in FIG. 5. Application screening function 524 of LIM 504 may determine whether the received message is being communicated between domains of different type by examining the destination point code in the received message. If the destination point code in the message is an alias, the message may be identified as being communicated between domains of different type. For example, message routing function 526 may access a database 534 including true and alias point codes for transmitting messages between domains of different type. If the true point code in the routing table is the same as the destination point code of the message, the message is being communicated within the same domain in which it originated, and the message can be forwarded through routing node 102 for further processing and outbound communication by LIM 506 (step 604). Otherwise, if the true point code in the routing table is not the same as the destination point code of the message, the message is being communicated between domains of different type. If the received message is being communicated between domains of different type, the process proceeds to step 606.

In an alternate implementation, it may be determined that the received message is being transmitted between domains of different type by examining the inbound and outbound linkset types for the message. If the linkset type of the inbound linkset is different than the outbound linkset, it may be known that the message is being transmitted between domains of different type.

As stated above, it may be desirable to include or exclude certain messages from MSM screening processing based on incoming linkset. Accordingly, in step 606 of FIG. 6A, it is determined whether the message was received on a predetermined linkset, which in this example corresponds to a candidate linkset for which MS address replacement may be performed. If it is determined that the message was not received on a predetermined linkset, the message can be forwarded through routing node 102 for further processing and outbound communication by LIM 506 (step 604). Otherwise, if it is determined that the message was received on a predetermined linkset, the process can proceed to step 608.

Referring to step 608 of FIG. 6A, it is determined whether the originating point code is a predetermined originating point code. If it is determined that the originating point code of the received message is not a predetermined originating point code, the message can be forwarded through routing node 102 for further processing and outbound communication by LIM 506 (step 604). Otherwise, it is determined that the originating point code of the received message is a predetermined originating point code, the process can proceed to step 610. Predetermined originating point codes may be the originating point codes for which MS address replacement is activated by an operator.

Step 610 of FIG. 6A and steps 612-624 of FIGS. 6B and 6C describe the replacement of the address value stored in the MS address parameter of the received message according to the subject matter described herein. The replacement process can be implemented by MS address replacement function 538 of routing node 102. Referring to step 610, the TCAP part of the received message is decoded. Next, at step 612 of FIG. 6B, it is determined whether the decoding of the TCAP part was successful. If decoding was not successful, the process proceeds to step 604. Otherwise, the process proceeds to step 614.

At step 614 of FIG. 6B, it is determined whether the received message is an ANSI TCAP or an IS-41 MAP message. If the received message is not an ANSI TCAP or an IS-41 MAP message, the process proceeds to step 604. Otherwise, if the message is an ANSI TCAP or an IS-41 MAP message, the process proceeds to step 616. In a GSM network, step 614 may include determining whether the message is a GSM MAP message.

Referring to FIG. 6B, in step 616, it is determined whether the received message is of a type used to communicate an address at which a mobile station can receive MS messages. This determination may be made by comparing the message type of the received message to a group of provisioned message types known to communicate MS delivery addresses. For example, the group of provisioned message types may include registration notification messages, SMS notification messages, and SMS request return result messages, in IS-41 networks. In GSM networks, step 616 may include determining whether the message is a location update message or other type of message used to communicate the address at which a roaming mobile station can receive MS messages. If it is determined that the received message is not one of the message types used to communicate an address at which a mobile station can receive MS messages, the message can be forwarded through routing node 102 for further processing and outbound communication and MTP routing by a routing function 542 (step 604). Otherwise, if it is determined that the received message is one of the provisioned message types, the process can proceed to step 618 of FIG. 6C. In step 618 of FIG. 6C, it is determined whether the received message includes a MS address parameter value. If it is determined that the message does not include an MS address parameter value, the message can be forwarded through routing node 102 for further processing and outbound communication and MTP routing by routing function 542 (step 604). Otherwise, if it is determined that the message includes an MS address parameter value, the process can proceed to step 620.

At step 620, it is determined whether the type of the MS address parameter value of the received message is “point code.” If it is determined that the type of the MS address parameter value of the received message is not “point code,” the message can be forwarded through routing node 102 for further processing and outbound communication and MTP routing by routing function 542 (step 604). Otherwise, if it is determined that the type of the MS address parameter value of the received message is “point code,” the process can proceed to step 622.

At step 622 of FIG. 6C, it is determined whether the routing table of routing function 542 includes an alias point code for the true point code in the MS address field of the received message. If it is determined that the routing table does not include an alias point code for the true point code in the MS address field, the message may be MTP routed by routing function 542 and forwarded to a destination interface module (step 604). Otherwise, if it is determined that the routing table includes an alias point code for the true point code in the MS address field, the process proceeds to step 624 of FIG. 6C. At step 624, the true point code in the MS address field of received message is replaced with the alias point code found in the routing table of routing function 542.

For example, for predetermined messages being delivered from an ITU origin to an ANSI destination, MS address replacement module 538 may replace the true ITU point code in the MS address parameter in the received message with an alias ANSI point code. Using the ITU point code in the MS address field of the message, an alias ANSI point code can be found in the routing table used by routing function 542. For predetermined messages being delivered from an ANSI origin to an ITU destination, MS address replacement module 538 may replace the true ANSI point code in the MS address field in the received message with an alias ITU point code.

Thus, the subject matter described herein includes methods, systems, and computer program products for facilitating delivery of messaging service messages between domains of different type. By using alias point codes and replacing point codes in messaging service messages with alias point codes, the subject matter described herein eliminates the need for protocol conversion of messaging service message signaling messages that are sent between domains of different type. In addition, the subject matter described herein can be distinguished from MTP level 3 protocol converters that only convert the MTP level 3 point code in messages that are sent between domains of different types.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A method for facilitating delivery of messaging service messages between domains of different type, the method comprising:
(a) receiving a messaging service (MS) message including an MS address parameter storing a first address value of a first domain type and being located in an application part of the message;
(b) determining whether the MS message is being sent from a first domain of the first domain type to a second domain of a second domain type, the first domain type being different from the second domain type;
(c) determining whether the MS message is of a type used to communicate an MS delivery address at which a mobile station can receive MS messages; and
(d) in response to determining that the MS message is being sent from the first domain of the first domain type to the second domain of the second domain type and in response to determining that the MS message is of a type used to communicate an MS delivery address at which a mobile station can receive MS messages, replacing the first address value with a second address value of the second domain type.

2. The method of claim 1 wherein the MS message comprises a message selected from the group consisting of a registration notification message, an SMS notification message, and an SMS request return result message.

3. The method of claim 1 wherein the first address value comprise a point code for identifying a mobile switching center (MSC) serving the mobile station.

4. The method of claim 1 wherein the messaging service message comprises a global system for mobile communications (GSM) location update message.

5. The method of claim 1 wherein the first domain type is an International Telecommunications Union (ITU) domain type and the second domain type is an American National Standards Institute (ANSI) domain type.

6. The method of claim 1 wherein the first domain type is an American National Standards Institute (ANSI) domain type and the second domain type is an International Telecommunications Union (ITU) domain type.

7. The method of claim 1 wherein determining whether the MS message is being sent from a first domain of a first domain type to a second domain of a second domain type includes determining whether a message transfer part destination point code of the MS message is an alias point code.

8. The method of claim 1 wherein step (c) includes determining whether the MS message is one of a group of selected message types.

9. The method of claim 8 wherein the group of selected message types a registration notification message, an SMS notification message, and an SMS request return result message.

10. The method of claim 8 wherein the group of selected message types includes a global system for mobile communications (GSM) location update message.

11. The method of claim 8 wherein replacing the first address value includes replacing the first address value in response to the MS message being one of the messages selected from the group.

12. The method of claim 1 wherein the second address value comprises an alias address for a node of the second domain type.

13. The method of claim 12 wherein the alias address comprises a point code of the second domain type.

14. A system for facilitating delivery of messaging service (MS) messages between domains of different types, the system comprising:
(a) a communications module for receiving an MS message including an MS address parameter storing a first address value of a first domain type and being located in an application layer portion of the message;
(b) a screening module for determining whether the MS message is being sent from a first domain of the first domain type to a second domain of the second domain type; and
(c) an MS address replacement module for receiving the MS message from the screening module in response to the determination that the message is being sent from the first domain to the second domain, for determining whether the MS message is of a type use to communicate an MS delivery address at which a mobile station can receive MS messages, and, in response to determining that the MS message is of a type used to communicate an MS delivery address at which a mobile station can receive MS messages, for replacing the first address value with a second address value of the second domain type.

15. The system of claim 14 wherein the MS message comprises a message selected from the group consisting of a registration notification message, an SMS notification message, and an SMS request return result message.

16. The system of claim 14 wherein the first address value comprises a point code for identifying a mobile switching center (MSC) serving the mobile station.

17. The system of claim 14 wherein the messaging service message comprises a global system for mobile communications (GSM) location update message.

18. The system of claim 14 wherein the first domain type is an International Telecommunications Union (ITU) domain type and the second domain type is an American National Standards Institute (ANSI) domain type.

19. The system of claim 14 wherein the first domain type is an American National Standards Institute (ANSI) domain type and the second domain type is an International Telecommunications Union (ITU) domain type.

20. The system of claim 14 wherein, in determining whether the MS message is being sent from a first domain of a first domain type to a second domain of a second domain type, the screening module is operable to determine whether a destination point code of the MS message is an alias point code.

21. The system of claim 14 wherein, in determining whether the MS message is of a type use to communicate an MS delivery address at which a mobile station can receive MS messages, the MS address replacement module is adapted to determine whether the MS message is one of a group of selected MS message types.

22. The system of claim 21 wherein the group of selected MS message types includes a registration notification message, an SMS notification message, and an SMS request return result message.

23. The system of claim 21 wherein the group of selected MS message types includes a global system for mobile communications (GSM) location update message.

24. The system of claim 14 wherein the second address value comprises an alias point code of the second domain type corresponding to a node serving the mobile station.

25. A computer program product comprising computer executable instructions embodied in a computer readable medium for performing steps comprising:
(a) receiving a messaging service (MS) message including an MS address parameter storing a first address value of a first domain type and being located in an application part of the message;
(b) determining whether the MS message is being sent from a first domain of the first domain type to a second domain of the second domain type, the first domain type being different from the second domain type;
(c) determining whether the MS message is of a type used to communicate an MS delivery address at which a mobile station can receive MS messages; and
(d) in response to determining that the MS message is being sent from the first domain of the first domain type to the second domain of the second domain type and in response to determining that the MS message is of a type used to communicate an MS delivery address at which a mobile station can receive MS messages, replacing the first address value with a second address value of the second domain type.

26. The computer program product of claim 25 wherein the MS message comprises a message selected from the group consisting of a registration notification message, an SMS notification message, and an SMS request return result message.

27. The computer program product of claim 25 wherein the first address value comprises a point code for identifying a mobile switching center (MSC) serving the mobile station.

28. The computer program product of claim 25 wherein the messaging service message comprises a global system for mobile communications (GSM) location update message.

29. The computer program product of claim 25 wherein the first domain type is an International Telecommunications Union (ITU) domain type and the second domain type is an American National Standards Institute (ANSI) domain type.

30. The computer program product of claim 25 wherein the first domain type is an American National Standards Institute (ANSI) domain type and the second domain type is an International Telecommunications Union (ITU) domain type.

31. The computer program product of claim 25 wherein determining whether the MS message is being sent from a first domain of a first domain type to a second domain of a second domain type includes determining whether a message transfer part destination point code of the MS message is an alias point code.

32. The computer program product of claim 25 wherein step (c) includes determining whether the MS message is one of a group of selected message types.

33. The computer program product of claim 32 wherein the group of selected message types includes a registration notification message, an SMS notification message, and an SMS request return result message.

34. The computer program product of claim 32 wherein the group of selected message types includes a global system for mobile communications (GSM) location update message.

35. The computer program product of claim 25 wherein the second address value comprises and alias address of the second domain type for a node serving the mobile station.

36. The computer program product of claim 35 wherein the alias address comprises a point code of the second domain type.
